(19) United States
(12) Patent Application Publication
(10) Pub. No.: US 2022/0126862 A1
(43) Pub. Date: Apr. 28, 2022

(54) MAN-MACHINE HYBRID DECISION METHOD AND SYSTEM BASED ON CLOUD, AND CLOUD SERVER

(71) Applicant: SHENZHEN GUO DONG INTELLIGENT DRIVE TECHNOLOGIES CO., LTD, SHENZHEN (CN)

(72) Inventor: JIANXIONG XIAO, SHENZHEN (CN)

(21) Appl. No.: 17/341,419

(22) Filed: Jun. 8, 2021

(30) Foreign Application Priority Data
Oct. 27, 2020 (CN) 202011164594.1

(51) Int. Cl. B60W 60/00; B60W 50/02; G06N 5/04; B60W 40/06

(52) U.S. Cl. CPC B60W 60/0011; B60W 50/0205; G06N 5/045; B60W 2756/10; B60W 2556/45; B60W 2556/40; B60W 40/06

(57) ABSTRACT

The invention provides a man-machine hybrid decision method based on cloud, the man-machine hybrid decision method based on cloud comprising: the autonomous driving vehicle sending a request to a cloud server, and the request includes real-time data about the autonomous driving vehicle, an abnormal event that triggering the request, and vehicle information; the cloud server obtaining the request; the cloud server distributing the request to corresponding terminals; the terminal obtaining the request; the terminal generating a solution according to the real-time data and the abnormal event, and sending the solution to the cloud server; the cloud server transmitting the solution to the autonomous driving vehicle.

### CROSS REFERENCE TO RELATED APPLICATION

This non-provisional patent application claims priority under 35 U.S.C. § 119 from Chinese Patent Application No. 202011164594.1 filed on Oct. 27, 2020, the entire content of which is incorporated herein by reference.

### TECHNICAL FIELD

The disclosure relates to the field of autonomous driving technology, and particularly relates to a man-machine hybrid decision method and system based on cloud, and a cloud server.

### BACKGROUND

Nowadays, general autonomous driving vehicles on the market are in level-four. The autonomous driving vehicles in level-four can be operated unmanned to complete driving task under a certain condition. The certain condition indicates that the autonomous driving vehicles and the road both should meet limitation conditions. When some emergencies or complex problems occurs, the autonomous driving vehicle can't deal with the emergencies or complex problems by itself because of the limitation conditions. For example, when the autonomous driving vehicle stops driving for a long time without traffic jam, and an abnormal parking time of the autonomous driving vehicle exceeds a predetermined time, the autonomous driving vehicle will transmit a request to a cloud server via the Internet to obtain a solution.

However, the general solution methods for incidents of the autonomous driving vehicles via interaction with the cloud are that when the cloud server obtains the request of autonomous driving vehicle, the cloud server distributes the request to an artificial expert, who provides the solution for the request. However, there are not enough artificial experts and there are a lot of requests, the requests can't be processed in time and effectively, and it results that the abnormal parking state of autonomous driving vehicles last for a long time.

In order to improve the efficiency of interaction between autonomous driving vehicle and cloud server to process the request of autonomous driving vehicle in time, it is necessary to provide man-machine hybrid decision method.

### SUMMARY

The disclosure provides a man-machine hybrid decision method and system based on cloud, and a cloud server. The man-machine hybrid decision method and system based on cloud improve the efficiency of interaction between autonomous driving vehicle and cloud server to process the request of autonomous driving vehicle in time.

A first aspect of the disclosure provides a man-machine hybrid decision method based on cloud, the man-machine hybrid decision method based on cloud comprising: an autonomous driving vehicle sending a request to a cloud server, and the request includes real-time data about the autonomous driving vehicle, an abnormal event that triggering the request, and vehicle information; the cloud server obtaining the request;

the cloud server distributing the request to corresponding terminals; the terminal obtains the request; the terminal generating a solution according to the real-time data and the abnormal event, and sending the solution to the cloud server; the cloud server transmitting the solution to the autonomous driving vehicle.

A second aspect of the disclosure provides a man-machine hybrid decision method based on cloud, the man-machine hybrid decision method based on cloud comprising: an cloud server obtaining the request sent by the autonomous driving vehicle, the request includes real-time data about the autonomous driving vehicle, an abnormal event that triggering the request, and vehicle information; the cloud server distributing the request to corresponding terminals; when the cloud server receiving a solution of the request, transmitting the solution to the autonomous driving vehicle, the solution being generated by the terminal responding to the request.

The cloud server classifies the requests into the different types, and distributes the different types of the request to different types of the terminals accordingly, so that the requests from the autonomous driving vehicles can be responded fast, and the problem of low interaction efficiency between autonomous driving vehicle and cloud server will be solved.

### BRIEF DESCRIPTION OF THE DRAWINGS

In order to illustrate the technical solution in the embodiments of the disclosure or the prior art more clearly, a brief description of drawings required in the embodiments or the prior art is given below. Obviously, the drawings described below are only some of the embodiments of the disclosure. For ordinary technicians in this field, other drawings can be obtained according to the structures shown in these drawings without any creative effort.

FIG. 1A illustrates a flow diagram of the man-machine hybrid decision method based on cloud in accordance with a first embodiment.

FIG. 1B illustrates a diagram of the man-machine hybrid decision system in accordance with an embodiment.

FIG. 2 illustrates a sub-flow diagram of the man-machine hybrid decision system in accordance with a first embodiment.

FIG. 3 illustrates a scene where an autonomous driving vehicle cannot drive due to obstacles in accordance with an embodiment.

FIG. 4 illustrates a sub-flow diagram of the man-machine hybrid decision method in accordance with second embodiment.

FIG. 5 illustrates a sub-flow diagram of the man-machine hybrid decision method in accordance with a third embodiment.

FIG. 6 illustrates a sub-flow diagram of the intelligent terminal processing request in accordance with a fourth embodiment.

FIG. 7 illustrates a sub-flow chart of the expert terminal processing request in accordance with a fourth embodiment.

FIG. 8A-8C illustrate an interface displaying by an expert terminal in accordance with embodiments.

FIG. 9 illustrates a flow diagram of the man-machine hybrid decision method in accordance with a second embodiment.

### DETAILED DESCRIPTION OF THE EMBODIMENTS

In order to make the purpose, technical advantages of the disclosure more clearly, the disclosure is further described in detail in combination with the drawings and embodiments. It is understood that the specific embodiments described herein are used only to explain the disclosure and are not used to define it. On the bases of the embodiments in the disclosure, all other embodiments obtained by ordinary technicians in this field without any creative effort are covered by the protection of the disclosure.

The terms “first”, “second”, “third”, “fourth”, if any, in the specification, claims and drawings of this application are used to distinguish similar objects and need not be used to describe any particular order or sequence of priorities. It should be understood the data used here are interchangeable where appropriate, in other words, the embodiments described can be implemented in order other than what is illustrated or described here. In addition, the terms “include” and “have” and any variation of them, can encompass other things. For example, processes, methods, systems, products, or equipment that comprise a series of steps or units need not be limited to those clearly listed, but may include other steps or units that are not clearly listed or are inherent to these processes, methods, systems, products, or equipment.

It is to be noted that the references to “first”, “second”, etc. in the disclosure are for descriptive purpose only and neither be construed or implied the relative importance nor indicated as implying the number of technical features. Thus, feature defined as “first” or “second” can explicitly or implicitly include one or more such features. In addition, technical solutions between embodiments may be integrated, but only on the basis that they can be implemented by ordinary technicians in this field. When the combination of technical solutions is contradictory or impossible to be realized, such combination of technical solutions shall be deemed to be non-existent and not within the scope of protection required by the disclosure.

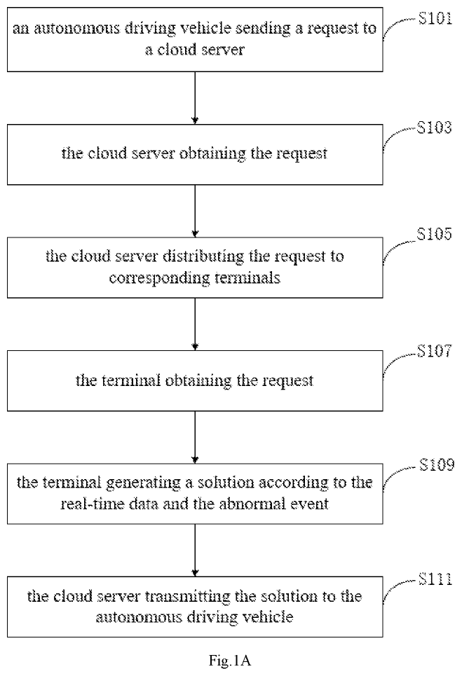

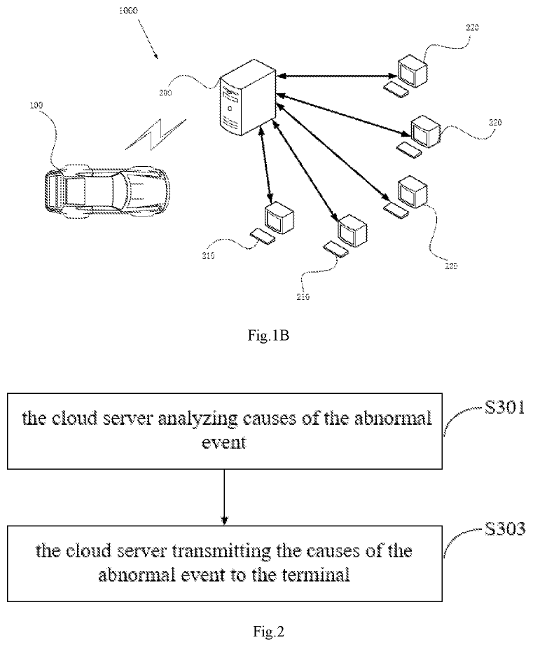

Referring to FIG. 1B, FIG. 1B illustrates a diagram of the man-machine hybrid decision system in accordance with an embodiment. The man-machine hybrid decision method based on cloud is executed by a man-machine hybrid decision system 1000 based on cloud. The man-machine hybrid decision system 1000 includes a cloud server 200, a plurality of autonomous driving vehicles 100, and a plurality of terminal. In this embodiment, a plurality of terminal includes a plurality of intelligent terminals 220 and a plurality of expert terminals 210. The man-machine hybrid decision method based on cloud includes following steps.

Referring to FIG. 1A, FIG. 1A illustrates a flow diagram of the man-machine hybrid decision method based on cloud in accordance with a first embodiment.

In step S101, an autonomous driving vehicle sending a request to a cloud server, and the request includes real-time data about the autonomous driving vehicle, an abnormal event that triggering the request, and vehicle information. In detail, the autonomous driving vehicle encounters accidents during driving, the accident maybe but not limited to a traffic accident just occurs on the road ahead of the autonomous driving vehicle that a driving lane of the autonomous driving vehicle driving on is occupied. Under limitation conditions, of the autonomous driving vehicles, the autonomous driving vehicle can't make decisions, and park at a current position to wait for decisions. When the autonomous driving vehicle spends for a time exceeding a predetermined time, the autonomous driving vehicles send a request to a cloud server for assistance.

In detail, the request includes real-time data, abnormal event triggering the request and vehicle information. The real-time data includes but is not limited to real-time image data and real-time point cloud data. The real-time image data can be real-time acquired by an image sensor installed on the autonomous driving vehicle, and the real-time point cloud data can be real-time acquired by lidars installed on autonomous driving vehicle.

In detail, the abnormal event includes that states of autonomous driving vehicle and how long the autonomous driving vehicle stops unexpectedly. The states of autonomous driving vehicle include all the elements of high-definition (HD) map, states of vehicle hardware, state of the man-machine hybrid decision system itself, driving states of the autonomous driving vehicle, etc. Furthermore, the all elements of the HD maps include initial paths, lane lines, lane center lines, etc. The states of vehicle hardware include chassis states, sensor states, and other hardware states information. The vehicle information includes license plate, vehicle types, vehicle payment levels, etc.

In the step S103, the cloud server obtaining the request. The cloud server obtains the request from the autonomous driving vehicle through 4G, 5G or other communication network.

In the step S105, the cloud server distributing the request to corresponding terminals. according to a predetermined rule. The predetermined priority rule includes but is not limited to the following rules: (1) the repeated unsolved request has the highest priority. For example, the autonomous driving vehicle sends the request again when the has just sent the request, and it indicates that the autonomous driving vehicle may have been waiting for a long time, so the request is set as the highest priority. (2) The autonomous driving vehicle has a higher the payment level, a predetermined priority rule of the request sent by the autonomous driving vehicles is higher, for example, luxury cars has a higher priority than ordinary cars. (3) The autonomous driving vehicle has a longer the waiting time, the predetermined priority rule of the request by the autonomous driving vehicle is the higher. (4) The request has more incomplete information, the priority of the request is lower. For example, the request needs longer time to transmit traffic data, and the priority is lower before the transmission is completed. (5) The request can't be resolved remotely, the request the priority of the request is lower. For example, if the autonomous driving vehicle itself fails to interact with the cloud server, the cloud server can't response to the request, and the autonomous driving vehicle should need other ways of assistance. Furthermore, the cloud server sets the predetermined priority rule of the received request according to the above rules, and the request with high priority is distributed to the terminal first.

As illustrated in FIG. 1B, the cloud server 200 includes a plurality of expert terminals 210 and intelligent terminals 220. The cloud server 200 is capable of distributed the requests from the autonomous driving vehicles 100 to the idle expert terminals 210 and idle intelligent terminals 220 according to a predetermined priority rule and causes of the events triggering the request. the cause of the events includes a first type and second type. The request triggered by the event with first type cause is sent to the intelligent terminals 220 and the request triggered by the event with second type cause is sent to expert terminals 210.

In the step S107, the terminal obtaining the request. The terminal obtains the request distributed by the cloud server through 4G, 5G or other communication network.

In the step S109, the terminal generating a solution according to the real-time data and the abnormal event, and sending the solution to the cloud server, and sends the solution to the cloud server. The terminal sends the solution to the cloud server through 4G, 5G or other communication network.

In the step S111, the cloud server transmitting the solution to the autonomous driving vehicle. The cloud server sends the solution to the autonomous driving vehicle through 4G, 5G or other communication methods.

As described above, the man-machine hybrid decision method based on cloud enable the cloud server to transmit the request containing real-time data about the autonomous driving vehicle, an abnormal event that triggering the request, and vehicle information, and can distribute the request to a corresponding terminal based on the real-time data about the autonomous driving vehicle, an abnormal event that triggering the request, and vehicle information.

Referring to FIG. 2, it illustrates sub-flow diagram of the step S105. How the cloud server distributes the request further includes the following steps.

In the step S301, the cloud server analyzing causes of the abnormal event, the causes of the abnormal event including abnormal conditions of road that the autonomous driving vehicle driving on, and malfunctions of the autonomous driving vehicle. The causes of the abnormal event mainly include but are not limited to that: (1) There is no way for the autonomous driving vehicles to drive on, and the real road condition conflicts with an original planned path, and the autonomous driving vehicles can't decide whether to turn around. As shown in FIG. 3, there is an obstacle, such as a fallen tree 150 in front of the autonomous driving vehicle 100 lay on a path on which the autonomous driving vehicle 100 are driving, and the fallen tree 150 is not contained in the HD map while a sensor installed on the autonomous driving vehicle 100 detect that the fallen tree 150 is in front of the autonomous driving vehicle 100, and the autonomous driving vehicle can't decide a next action. (2) If the autonomous driving vehicles modify a few limitation conditions, there is a way for the autonomous driving vehicles 100 to drive on. However, the autonomous driving vehicles 100 are restricted to modify the limitation conditions, and only human experts are allowance to modify the limitation conditions. (3) Algorithms of the autonomous driving vehicles are too conservative. For example, the autonomous driving vehicles can't predict behaviors of trees which are similar with a person. (4) There are malfunctions in sensors, the automatic driving artificial intelligence system of the autonomous driving vehicle. For example, when the autonomous driving vehicle detects the malfunction, the autonomous driving vehicles send requests to the cloud server for assistance. (5) When the communication is bad, the autonomous driving vehicles can't receive the real-time information in time, and the autonomous driving vehicles send the requests to cloud server. (6) When the information contained in the high-precision map conflicts with perception information of the autonomous driving vehicles, the autonomous driving vehicle can't make decisions, and send requests to the cloud server for assistance.

As described above, the causes types include the first type related to abnormal condition of road that the autonomous driving vehicles are driving on, and the second type related to malfunctions of the autonomous driving vehicles. The request triggered by the event with first type cause is sent to the intelligent terminals 220 and the request triggered by the event with second type cause is sent to expert terminals 210. For example, when the requests are triggered by the causes (1) (3) (4) (5), the first type of request can be directly found in the cloud server and the database of the intelligent terminal. When the requests are triggered by the causes (2) (6), the request can't be found in the cloud server and the database of the intelligent terminals, also cannot be directly processed by the intelligent terminal and needs to be processed by the expert terminals. When the requests triggered by the causes (2) (6) can't be found in the cloud server and the database of the intelligent terminals, the cloud server can modify the causes of triggering the requests from the first type to the second type.

In the step S303, the cloud server transmitting the causes of the abnormal event to the terminal. Specifically, the cloud server distributes the request with the first type of causes and the highest priority to the intelligent terminal, and distributes the request with the first type of causes and the highest priority to the expert terminal. In this embodiment, each of the intelligent terminals has a large amount of data and powerful computing power. The expert terminal is the terminal that includes a display and can be operated by the human experts. The human experts are located all over the word and who only process one request at a time.

As described above, the cloud server sets the request priority according to the predetermined priority rules, and analyzes the type of the cause according to the abnormal event; the cloud server distributes the requests to the corresponding terminals according to the request priority and the type of the cause. And the requests can be quickly classified and processed, the intelligent terminal can quickly analyze the information in the request and give the solution, and the expert terminal also reduces the workload, gives the solution in time, and improves the efficiency of processing the request. The efficiency of responding to the requests is improved.

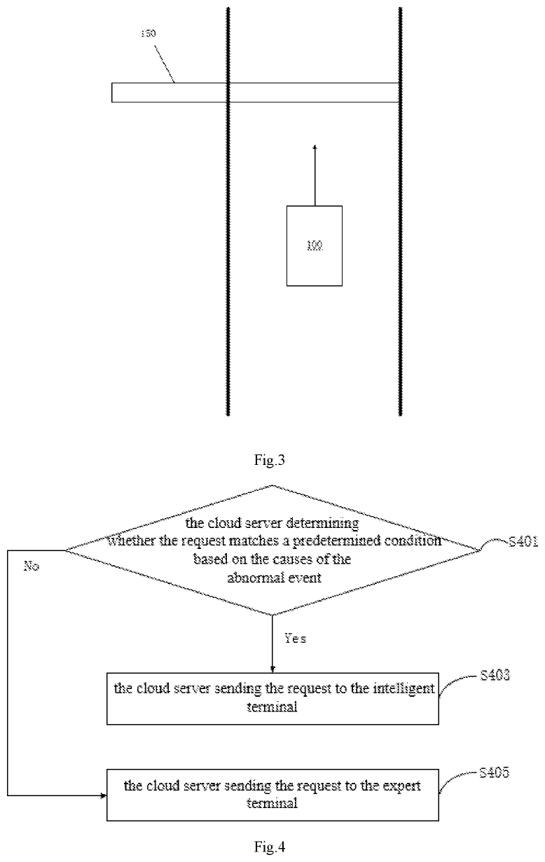

Refer to FIG. 4, FIG. 4 illustrates sub-flow diagram of the step S203. The step S203 includes the following steps.

In the step S401, the cloud server determining whether the request matches a predetermined condition based on the causes of the abnormal event. Specifically, the cloud server determines whether the request matches the predetermined condition by determines whether the type of the causes triggering the request is the first type. In detail, the cloud server determines that the request matches the predetermined condition when the type of the causes triggering the request is the first type. For example, a big tree is located on the road on which the autonomous driving vehicle is driving, the autonomous driving vehicle fails to make decision and sends a request to the cloud server. The cloud server sets the type of the cause triggering the request as the first type, and the cloud server further determines the request matches a predetermined condition.

In the step S403, when the request matches the predetermined condition, the cloud server sending the request to the intelligent terminal. Specifically, if the type of the cause triggering the request is the first type, the request is distributed to the intelligent terminal.

In the step S405, when the request doesn't match the predetermined condition, the cloud server sending the request to the expert terminal. Specifically, if the type of the cause triggering the request is the second type, the request is distributed to the expert terminal.

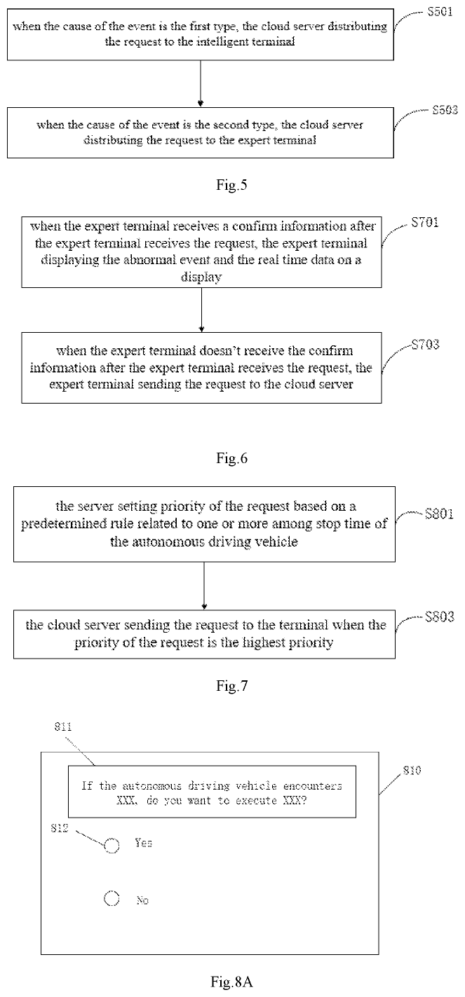

Refer to FIG. 5, FIG. 5 illustrates a sub flow diagram of the step S401. The step S401 includes the following steps.

In step S501, when the cause of the event is the first type, the cloud server distributing the request to the intelligent terminal. If the intelligent terminal does not propose a solution for the request, the request is sent to the cloud server, and the type of the cause is changed from the first type to the second type. Specifically, when the intelligent terminal does not get the solution of the request after searching for database and calculating based on the real-time data, and the intelligent terminal sends the request to the cloud server, and the cloud server changes type of the cause of triggering the request from the first type to the second type.

In the step S503, when the cause of the event is the second type, the cloud server distributing the request to the expert terminal. when the intelligent terminal is unable to solve the request, changes the type of the cause from the first type to the second type.

Referring to FIG. 6, FIG. 6 illustrates the sub-follow diagram of the step S109. The step S109 includes the following steps.

In the step S701, when the expert terminal receives a confirm information after the expert terminal receives the request, the expert terminal displaying the abnormal event and the real time data on a display.

In the step S703, when the expert terminal doesn't receive the confirm information after the expert terminal receives the request, the expert terminal sending the request to the cloud server.

For example, when the abnormal event is that an unknown obstacle locates on the road on which the autonomous driving vehicle is driving on, the intelligent searches for common solution for the autonomous driving vehicle to resolve the abnormal event to determine whether the solution exists in the database. In detail, the intelligent terminal calculates the real-time data and abnormal event to generate an available solution for the autonomous driving vehicle when the unknown obstacle locates on the road on which the autonomous driving vehicle is driving on. The available solution for the autonomous driving vehicle maybe an instruction to control the autonomous driving vehicle to turn around, or maybe paths for the autonomous driving vehicle to drive along.

When the intelligent terminal does not obtain the solution, the intelligent terminal sends the request to the cloud server. For example, when relationship between a road and the unknown obstacle is complex, the intelligent terminal can't generate the solution after calculating, and it is determined that the intelligent terminal can't process the request, and the intelligent terminal sends the request to the cloud server to enable the cloud server to transmit the request to the expert terminal. In other words, when the request can't be processed by the intelligent terminal, the request will be sent to the expert terminal to process.

Refer to FIG. 7, FIG. 7 illustrates a flow diagram to performed by the expert terminal to generate the solution. When the terminal is the expert terminal, the man-machine hybrid decision method based on cloud further comprises the following steps.

In the step S801, the server setting priority of the request based on a predetermined rule related to one or more among stop time of the autonomous driving vehicle, service fees of the autonomous driving vehicle, number of repeated requests of the autonomous driving vehicle, and sending time of the request.

In the step S803, the cloud server sending the request to the terminal when the priority of the request is the highest priority.

the expert terminal determines a type of processing modes based on the abnormal event, the type of the processing modes includes a multiple choice type and a editable type. In detail, the expert terminal receives the request, the expert terminal calculates one solution. When the expert terminal can't determine whether the one solution is suitable for the autonomous driving vehicle, the expert terminal displays the one solution and provides a confirm icon that the confirm icon will be selected as the solution suitable for the request or not by the human expert. When the expert terminal calculates a plurality of solutions, the expert terminal provides a plurality of selective icons that one of the selective icons will selected as the solution suitable for the request. When the expert terminal can't calculate any solution, the confirm icon will be selected as the solution for the request by the expert terminal displays the real-time data and the high-precision map for the human expert to edit a solution suitable for the request. Further, when the type of the processing mode is the multiple choices type.

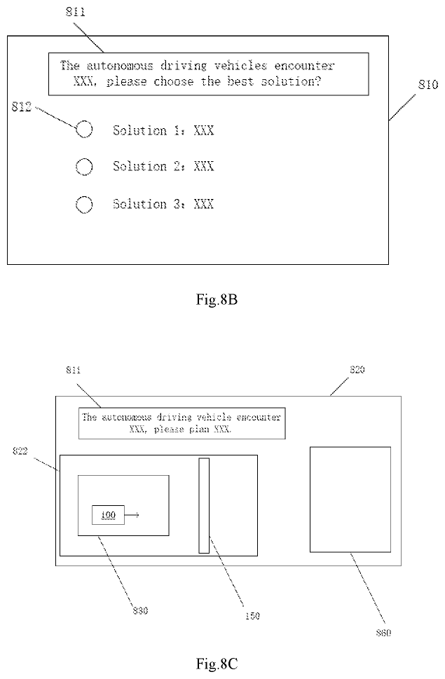

The expert terminal displays a plurality of solutions to enable a human expert to chose. For example, When the expert terminal can't determine whether the one solution is suitable for the autonomous driving vehicle, the expert terminal displays the one solution and provides a confirm icon that the confirm icon will be selected as the solution suitable for the request or not by the human expert. In detail, as shown in the FIG. 8A-8B, the expert terminal displays a selection page 810. The selection page 810 provides a cause displaying area 811 and two select buttons 812. The cause of event triggering the request is displayed in the cause display area 811. Beside the each select button 812, there is Yes or no, which indicates one selected button is a “Yes” button, and the other one selected button is “No”. When the “Yes” button is selected, the one solution is select as the solution suitable for the request. For another example, when the expert terminal provides more than one solution for the request which need the human expert human to determine which one is suitable for the request, the expert terminal displays the solutions for the human experts to choose. In detail, as shown as FIG. 8C, the expert terminal displays the selection page 810, the selection page 810 includes a cause displaying area 811 and select buttons 812. The causes of the event triggering the request and select icons corresponding to each of the causes are displayed in displaying area 811. Besides each selection buttons, there is a solution which indicates the solution for the corresponding cause. When one selected button 812 is selected, the corresponding solution is the suitable for the request.

The expert terminal generates the solution for the request based on the solution choose by the human expert.

The expert terminal displays the editable content to enable a human expert to edit. Specifically, the human expert edits the area on the high-precision map and replan the driving area of autonomous driving vehicles. The human expert can modify driving areas by moving, add or deleted control points of the high-precision map or the driving areas by inputting devices such as mouse or touch screen. The driving areas may be but not limited to polygon areas. For example, After the high-precision map also is modified, and the high-precision map of the autonomous driving vehicle is updated synchronously based on the modified content of the high-precision map, and the real time data is transmitting to the expert terminal via the cloud server simultaneously to edit the driving area via the human expert. And then the expert terminal generates the solution based on the modified driving areas. The expert terminal also displays the solution for human expert to confirmed again, the solution is confirmed, the solution is then transmitted to the cloud server. For example, as shown in FIG. 8C, the expert terminal displays an edit page 820, the edit page 820 includes the cause displaying area 811, the high-precision map 822, and a real time data displaying area 860. The human expert edits the driving area 830 in the high-precision map 822 based on the real time data displayed on the real time data displaying area 860. For example, the high-precision map 822 is edit to contain the fallen tree 150 and autonomous driving vehicle 100, and the human expert can edit a driving area for the autonomous driving vehicle to avoid the fallen tree 150. The expert terminal calculates the solution based on the driving area.

In other embodiments, the real-time display area 860 further displays freshness of the real-time data besides the real-time data. The freshness is an evaluation parameter of the real-time performance of the real-time data, and the freshness data is determined by the communication speed. The freshness means that the real-time data is unreliable or reliable. For example, when the freshness is too low, the real-time display area 860 will turn gray, which indicates that the real-time data is unreliable and not the latest data.

The expert terminal generates the solution according to the edited answer, and sends the solution to the cloud server. Specifically, the expert terminal computer device transforms the artificial experts' editing of the driving area and other rules into a solution, and sends the solution to the cloud server.

In other implementable embodiments, the request distributed by the cloud server to the expert terminal is a one-time task. If two requests sent by one autonomous driving vehicle continually need to be processed by expert terminals, the cloud server may distribute the two requests to two different expert terminals correspondingly.

In other implementable embodiments, the human expert needs to confirm whether accept the request or not before processing the request. Because the state is not maintained, the speed of processing the request can be fast, generally from 1 second to 10 seconds. In detail, when the human expert needs to leave the expert terminal temporarily or get off work, the human expert can choose to be offline, and the cloud server will no longer distributes the request to the expert terminal offline. When the human expert is online, the cloud server will distribute the request to the expert terminal, and remind the expert terminal via voice output by a speaker and pop-up window of the expert terminal. When the human expert fails to accept the request within a specified time, such as one second because that the human expert goes offline without pressing the offline button to turn to the offline, or falls asleep accidentally, or the network is disconnected suddenly. The expert terminal sends the request to the cloud server and sets the request to the highest priority, and the cloud server distributes the request to another expert terminal for the request. Once the manual expert accepts the request, expert terminal will display the relevant information to the manual expert and obtain the information inputted by the manual expert.

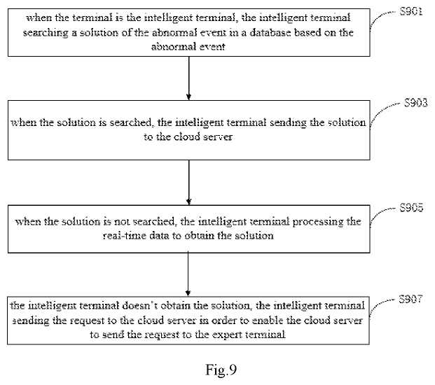

Referring to FIG. 9 for the solution archiving process provided for the embodiment of the invention. After the effective time of the solution is determined, the archiving steps of the solution are as follows.

In the step S901, when the terminal is the intelligent terminal, the intelligent terminal searching a solution of the abnormal event in a database based on the abnormal event.

In the step S903, when the solution is searched, the intelligent terminal sending the solution to the cloud server. Specifically, if the effective time is permanent, the solution always exists in the database and becomes permanent data in the database. If the valid time is permanent and the solution contains high-precision map data, the cloud server sends the solution to the high-precision map maintenance terminal to update the high-precision map. The data contained in the solution becomes the new data of high-precision map.

In the step S905, when the solution is not searched, the intelligent terminal processing the real-time data to obtain the solution.

In the step S907, when the intelligent terminal doesn't obtain the solution, the intelligent terminal sending the request to the cloud server in order to enable the cloud server to send the request to the expert terminal. Specifically, if the effective time is the specified time period, the solution can only exist in the database for the specified time period. Once the solution exceeds the specified time, the cloud server will delete or hide the solution. For example, for the solution of road repair for a certain road section, the maintenance time of the road section is one month, so the effective time of the solution is one month. After one month, the solution will no longer work, so it will be deleted from the database. For another example, if another solution is only applicable to 9:00-12:00 in the daytime, the solution will only be valid from 9:00-12:00 in the daytime and will be hidden in other time periods.

The method of setting effective time for the solution can improve the utilization rate of the database, reduce the occupation of useless information on the database, and improve the search efficiency of the database, to find a solution for the request faster and improve the overall information interaction efficiency.

This solution provides a man-machine hybrid decision method based on cloud, which is applied in the field of automatic driving, including autonomous driving vehicles sending requests to the cloud server, including real-time data of autonomous driving vehicles, abnormal event triggering requests, and vehicle information; cloud server getting requests; cloud server giving solutions according to real-time data, abnormal event and vehicle information and send the solution to the autonomous driving vehicle.

In the above-mentioned embodiment, the autonomous driving vehicle sends requests to the cloud server when encountering problems that cannot be decided. The cloud server classifies and prioritizes the requests, and assigns them to different terminals for processing according to the priority and type. Efficient request allocation makes full use of the resources of the cloud server, greatly speeds up the efficiency of receiving requests, and enables the cloud server to receive and process more requests in the same time. The way that different terminals process different types of requests give full play to the advantages of intelligent terminals, such as fast operation and flexible rules. So that the request can be processed in the shortest time, which greatly improves the efficiency of request decision-making. autonomous driving vehicle can solve the problem faster and enter the normal driving state.

The man-machine hybrid decision method based on cloud, where the intelligent terminal doesn't obtain the solution, the intelligent terminal sending the request to the cloud server in order to enable the cloud server to send the request to the expert terminal comprising: the expert terminal determining type of problem based on the abnormal event, the type of the request includes a multiple choice type and a editable type; when the type of problem is the multiple choice type, the expert terminal displaying a plurality of solutions to enable a human expert to choses; the expert terminal sending the solution chose by the human expert to the cloud sever; when the type of problem is the editable type, the expert terminal displaying the editable content to enable a human expert to edit; the expert terminal generating the solution based on the edited content.

The man-machine hybrid decision method based on cloud, the solution of includes an effective time, the effective time is a permanent effective time or a temporary effective time, the man-machine hybrid decision method based on cloud further comprising: when the cloud server receives the solution, added the solution to the database; and when the solution has the permanent effective time and the solution has high-precision map data, the cloud server sending the solution to a maintenance equipment of a high-precision map for updating the high-precision map; or when the solution has the temporary effective time and the temporary effective time arrived, the cloud server canceling from the database or hiding the solution in the database.

Referring FIG. 1B, FIG. 1B illustrates a diagram of the man-machine hybrid decision system in accordance with an embodiment. The man-machine hybrid decision system 1000 includes an autonomous driving vehicle 100; terminals 210, terminals 220, and a cloud server 200, the cloud server includes: a memory configured to store program instructions, and one or more processors, the one or more processor executing the program instructions to perform a man-machine hybrid decision method based on cloud executed by the cloud server as described above.

Obviously, those skilled in the art can make various changes and variations to the invention without departing from the spirit and scope of the invention. In this way, if these modifications and variations of the invention fall within the scope of the claims of the invention and its equivalents, the invention is also intended to include these modifications and variations.

The above cited examples are only the better embodiments of the invention, and certainly can't be used to limit the scope of the invention. Therefore, the equivalent changes made according to the claims of the invention still belong to the scope of the invention.

1. A man-machine hybrid decision method based on cloud, the man-machine hybrid decision method based on cloud comprising:
an autonomous driving vehicle sending a request to a cloud server, and the request includes real-time data about the autonomous driving vehicle, an abnormal event that triggering the request, and vehicle information;
the cloud server obtaining the request;
the cloud server distributing the request to corresponding terminals;
the terminal obtaining the request;
the terminal generating a solution according to the real-time data and the abnormal event, and sending the solution to the cloud server; and
the cloud server transmitting the solution to the autonomous driving vehicle.

2. The man-machine hybrid decision method based on cloud of claim 1, wherein the event includes that the autonomous driving vehicle stops driving while the autonomous driving vehicle should drive, and the autonomous driving vehicle stops driving for a time exceeding a predetermined time.

3. The man-machine hybrid decision method based on cloud of claim 1, further comprising:
the cloud server analyzing causes of the abnormal event, the causes of the abnormal event including abnormal conditions of road that the autonomous driving vehicle driving on, and malfunctions of the autonomous driving vehicle; and
the cloud server transmitting the causes of the abnormal event to the terminal.

4. The man-machine hybrid decision method based on cloud of claim 3, wherein the terminal includes an intelligent terminal and an expert terminal, the man-machine hybrid decision method based on cloud further comprising:
the cloud server determining whether the request matches a predetermined condition based on the causes of the abnormal event;
when the request matches the predetermined condition, the cloud server sending the request to the intelligent terminal; or
when the request doesn't match the predetermined condition, the cloud server sending the request to the expert terminal.

5. The man-machine hybrid decision method based on cloud of claim 4, wherein the cause of the event includes a first type and a second type, the man-machine hybrid decision method based on cloud further comprises:
when the cause of the event is the first type, the cloud server distributing the request to the intelligent terminal; or
when the cause of the event is the second type, the cloud server distributing the request to the expert terminal.

6. The man-machine hybrid decision method based on cloud of claim 5, further comprises:
when the intelligent terminal is unable to solve the request, changing the first type of the event to the second type.

7. The man-machine hybrid decision method based on cloud of claim 5, further comprises:
when the expert terminal receives a confirm information after the expert terminal receives the request, the expert terminal displaying the abnormal event and the real time data on a display; or
when the expert terminal doesn't receive the confirm information after the expert terminal receives the request, the expert terminal sending the request to the cloud server.

8. The man-machine hybrid decision method based on cloud of claim 5, further comprising:
the server setting priority of the request based on a predetermined rule related to one or more among stop time of the autonomous driving vehicle, service fees of the autonomous driving vehicle, number of repeated requests of the autonomous driving vehicle, and sending time of the request; and
the cloud server sending the request to the terminal when the priority of the request is the highest priority.

9. The man-machine hybrid decision method based on cloud of claim 4, wherein the terminal generating a solution according to the real-time data and the abnormal event, and sending the solution to the cloud server comprising:
when the terminal is the intelligent terminal, the intelligent terminal searching a solution of the abnormal event in a database based on the abnormal event;
when the solution is searched, the intelligent terminal sending the solution to the cloud server; or
when the solution is not searched, the intelligent terminal processing the real-time data to obtain the solution; and
when the intelligent terminal doesn't obtain the solution, the intelligent terminal sending the request to the cloud server in order to enable the cloud server to send the request to the expert terminal.

10. The man-machine hybrid decision method based on cloud of claim 4, wherein when the terminal is the expert terminal, the man-machine hybrid decision method based on cloud further comprising:
the expert terminal determining type of processing modes based on the abnormal event, the type of the processing modes includes a multiple choice type and a editable type;
when the type of the processing modes is the multiple choice type, the expert terminal displaying a plurality of solutions to enable a human expert to chose; and
the expert terminal sending the solution chose by the human expert to the cloud sever; or
when the type of the processing modes is the editable type, the expert terminal displaying the editable content to enable a human expert to edit; and
the expert terminal generating the solution based on the edited content.

11. The man-machine hybrid decision method based on cloud of claim 10, wherein the solution of includes an effective time, the effective time is a permanent effective time or a temporary effective time, the man-machine hybrid decision method based on cloud further comprising:
when the cloud server receives the solution, adding the solution to the database; and
when the solution has the permanent effective time and the solution has high-precision map data, the cloud server sending the solution to a maintenance equipment of a high-precision map for updating the high-precision map; or
when the solution has the temporary effective time and the temporary effective time arrives, the cloud server canceling the solution from the database or hiding the solution in the database.

12. A man-machine hybrid decision method based on cloud, the man-machine hybrid decision method based on cloud comprising:
a cloud server obtaining the request sent by the autonomous driving vehicle, the request includes real-time data about the autonomous driving vehicle, an abnormal event that triggering the request, and vehicle information;
the cloud server distributing the request to corresponding terminals; and
when the cloud server receiving a solution of the request, transmitting the solution to the autonomous driving vehicle, the solution being generated by the terminal responding to the request.

13. The man-machine hybrid decision method based on cloud of claim 12, wherein the event includes that the autonomous driving vehicle stops driving while the autonomous driving vehicle should drive, and the autonomous driving vehicle stops driving for a time exceeding a predetermined time.

14. The man-machine hybrid decision method based on cloud of claim 12, further comprising:
the cloud server analyzing causes of the abnormal event, the causes of the abnormal event including abnormal conditions of road that the autonomous driving vehicle driving on, and malfunctions of the autonomous driving vehicle; and
the cloud server transmitting the causes of the abnormal event to the terminal.

15. The man-machine hybrid decision method based on cloud of claim 12, wherein the terminal includes an intelligent terminal and an expert terminal, the man-machine hybrid decision method based on cloud further comprising:
the cloud server determining whether the request matches a predetermined condition based on the causes of the abnormal event;
when the request matches the predetermined condition, the cloud server sending the request to the intelligent terminal; or
when the request doesn't match the predetermined condition, the cloud server sending the request to the expert terminal.

16. The man-machine hybrid decision method based on cloud of claim 15, wherein the cause of the event includes a first type and a second type, the man-machine hybrid decision method based on cloud further comprises:
when the cause of the event is the first type, the cloud server distributing the request to the intelligent terminal; or
when the cause of the event is the second type, the cloud server distributing the request to the expert terminal.

17. The man-machine hybrid decision method based on cloud of claim 16, further comprises:
when the intelligent terminal is unable to solve the request, the cloud server changing the first type of the event to the second type.

18. The man-machine hybrid decision method based on cloud of claim 16, further comprising:
the server setting priority of the request based on a predetermined rule related to one or more among stop time of the autonomous driving vehicle, service fees of the autonomous driving vehicle, number of repeated requests of the autonomous driving vehicle, and sending time of the request; and
the cloud server sending the request to the terminal when the priority of the request is the highest priority.

19. The man-machine hybrid decision method based on cloud of claim 15, further comprising:
when the cloud server receives the request from the intelligent terminal, the cloud server to send the request to the expert terminal.

20. A man-machine hybrid decision system based on cloud, the man-machine hybrid decision system comprising:
an autonomous driving vehicle;
a terminal, and
a cloud server, the cloud server comprising:
a memory configured to store program instructions, and
one or more processors, the one or more processor executing the program instructions to perform a man-machine hybrid decision method based on cloud, the man-machine hybrid decision method based on cloud comprising;
obtaining the request sent by the autonomous driving vehicle, the request includes real-time data about the autonomous driving vehicle, an abnormal event that triggering the request, and vehicle information;
distributing the request to corresponding terminals; and
when a solution of the request is received, transmitting the solution to the autonomous driving vehicle, the solution being generated by the terminal responding to the request.
